(19) United States
(12) Patent Application Publication
(10) Pub. No.: US 2023/0160702 A1
(43) Pub. Date: May 25, 2023

(54) INFORMATION PROCESSING APPARATUS, INFORMATION PROCESSING SYSTEM, AND INFORMATION PROCESSING METHOD

(71) Applicant: DENSO TEN Limited, Kobe-shi, Hyogo (JP)

(72) Inventors: Shinichi TANAKA, Kobe-shi (JP); Shinichi SHIOTSU, Kobe-shi (JP); Haruki SHIRAISHI, Kobe-shi (JP); Minoru MAEHATA, Kobe-shi (JP); Miki HITOTSUYA, Kobe-shi (JP); Tomohiro IKEDA, Kobe-shi (JP); Toshiyuki MORIBAYASHI, Kobe-shi (JP); Natsumi NISHIYAMA, Kobe-shi (JP); Ryo MATSUI, Kobe-shi (JP)

(73) Assignee: DENSO TEN Limited, Kobe-shi, Hyogo (JP)

(21) Appl. No.: 17/923,090

(22) PCT Filed: Mar. 29, 2021
(86) PCT No.: PCT/JP2021/013236

§ 371 Date: Nov. 3, 2022

(30) Foreign Application Priority Data
Jul. 17, 2020 (JP) 2020-123086
Oct. 30, 2020 (JP) 2020-183036

(51) Int. Cl. G01C 21/34; G01C 21/36

(52) U.S. Cl. CPC G01C 21/3415; G01C 21/3691

(57) ABSTRACT

An information processing apparatus according to an aspect of an embodiment includes an acquisition unit, a selection unit, and a reward unit. The acquisition unit acquires congestion information including a congestion situation on a movement route from an event facility to a predetermined point, and user position information indicating a position of a user. The selection unit selects a target user from a plurality of the users, on the basis of the congestion information and user position information acquired by the acquisition unit. The reward unit provides the target user selected by the selection unit, with a reward according to the user position information of the target user.

### FIELD

The embodiments discussed herein are directed to an information processing apparatus, an information processing system, and an information processing method.

### BACKGROUND

Conventionally, various techniques have been proposed to relieve a congestion around event facilities at events such as concerts (see, e.g., Patent Literature 1). In the related art, when an event is held, an operation management system of a bus operator switches a mode of a bus stop at an event facility so that an extra bus can depart from the bus stop, reducing people waiting for buses.

### CITATION LIST

### Patent Literature

International Laid-open Patent Publication No. WO2016/079778

### SUMMARY

### Technical Problem

However, in the related art, there has been room for improvement, for example, in efficient relief of a congestion on a movement route from the event facility.

The present invention has been made in view of the above description, and an object of the present invention is to provide an information processing apparatus, an information processing system, and an information processing method that are configured to efficiently relieve a congestion on a movement route.

### Solution to Problem

An information processing apparatus according to the present disclosure includes an acquisition unit, a selection unit, and a reward unit. The acquisition unit acquires congestion information and user position information, the congestion information including a congestion situation on a movement route from an event facility to a predetermined point, the user position information indicating a position of a user. The selection unit selects a target user from a plurality of the users based on the congestion information and user position information acquired by the acquisition unit. The reward unit provides the target user selected by the selection unit with a reward, according to the user position information of the target user.

### Advantageous Effects of Invention

According to the present invention, the congestion on the movement route can be efficiently relieved.

### BRIEF DESCRIPTION OF DRAWINGS

FIG. 1 is a diagram illustrating an overview of an information processing method according to a first embodiment.

FIG. 2 is a block diagram illustrating a configuration example of an information processing system.

FIG. 3 is a block diagram illustrating a configuration example of an information processing apparatus.

FIG. 4 is a table illustrating an example of congestion information.

FIG. 5 is a table illustrating an example of user information.

FIG. 6 is a table illustrating an example of reward information.

FIG. 7 is a diagram illustrating a process performed by a selection unit and the like.

FIG. 8 is a flowchart illustrating a process procedure performed by the information processing apparatus.

FIG. 9 is a diagram illustrating an overview of an information processing method according to a second embodiment.

FIG. 10 is a diagram illustrating an overview of the information processing method according to the second embodiment.

FIG. 11 is a diagram illustrating an overview of the information processing method according to the second embodiment.

FIG. 12 is a block diagram illustrating a configuration example of an information processing apparatus according to the second embodiment.

FIG. 13 is a table illustrating an example of facility information.

FIG. 14 is a flowchart illustrating a procedure of a process performed by the information processing apparatus according to the second embodiment.

### DESCRIPTION OF EMBODIMENTS

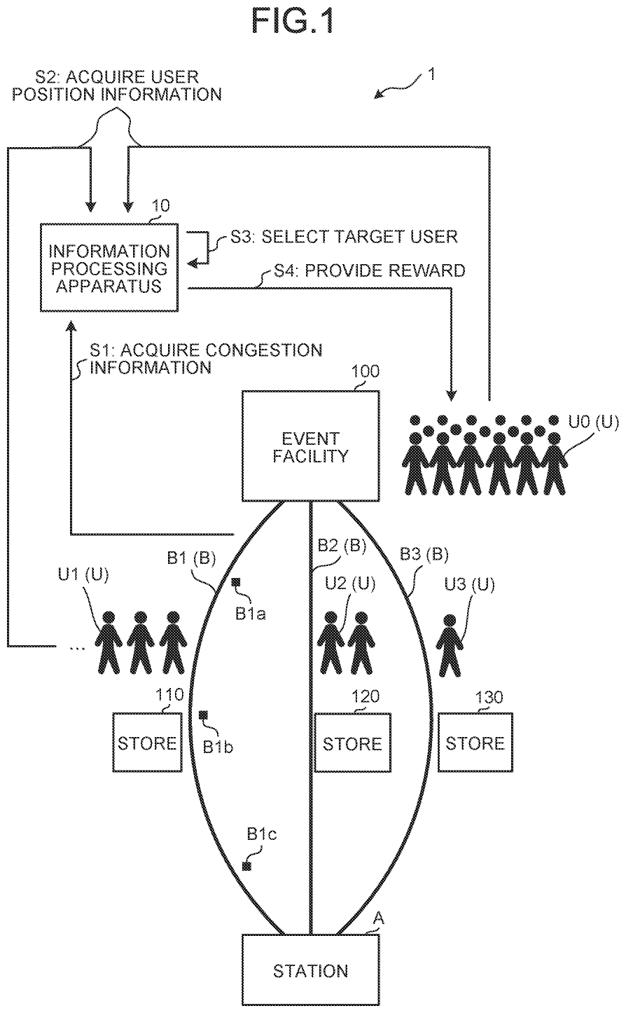

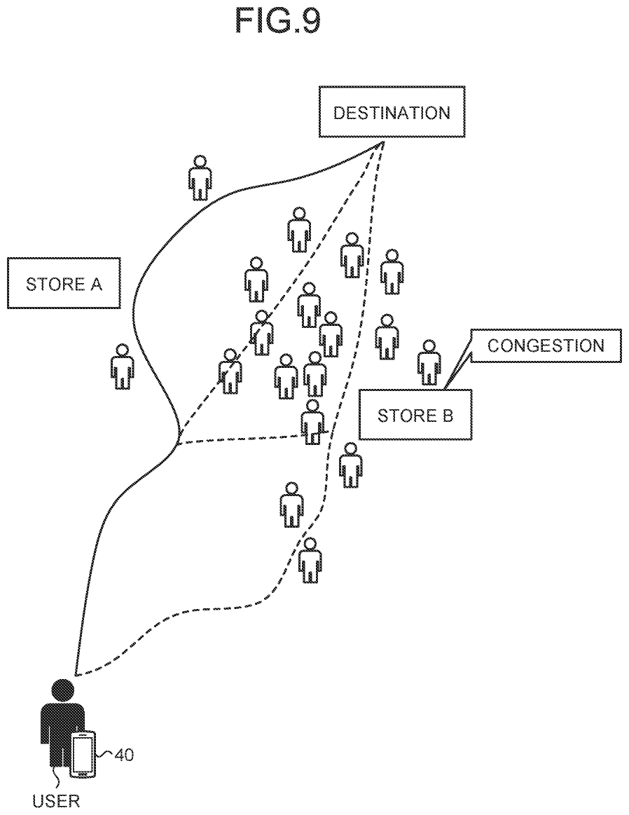

Embodiments of an information processing apparatus and an information processing method disclosed in the present application will be described in detail below with reference to the accompanying drawings. Note that the present invention is not limited by the embodiments described below. Furthermore, in the following, a first embodiment will be described with reference to FIGS. 1 to 8, and a second embodiment will be described with reference to FIGS. 9 to 14.

### First Embodiment

<Overview of Information Processing Method>

First, an overview of the information processing method according to the first embodiment will be described below with reference to FIG. 1. FIG. 1 is a diagram illustrating an overview of the information processing method according to the embodiment.

As illustrated in FIG. 1, the information processing method according to the first embodiment is performed by, for example, an information processing apparatus 10 included in an information processing system 1. The information processing apparatus 10 is a server that is configured to perform various processing such as processing of information about an event facility 100 and processing of information about the surroundings of the event facility 100. Here, the event facility 100 is, for example, a sports facility where an event such as a sport game is held, or a facility (venue) where an event such as a concert or a theatrical play is held.

In the event facility 100 (sometimes referred to as “facility 100”), for example, after the event, users who have used the facility 100, that is, people who have enjoyed the event come out of the facility 100 all at once. Therefore, for example, the vicinity of the facility 100 and a movement route B from the facility 100 to the nearest station A is congested.

Therefore, the information processing apparatus 10 according to the present embodiment is configured to efficiently relieve the congestion on the movement route B from the facility 100.

The processing in the information processing apparatus 10 will be described specifically below. First, the information processing apparatus 10 acquires congestion information including a congestion situation on the movement route B starting from the facility 100 (Step S1).

Note that FIG. 1 illustrates an example in which the movement route B is a movement route from the facility 100 to the station A. The station A is an example of a predetermined point. The station A is the nearest station from the facility 100, but may be, not limited thereto, any station as long as the station is around the facility 100. Note that, in the above description, the movement route B is the movement route from the facility 100 to the station A, but is not limited thereto, and may be, for example, a movement route to another transport station such as a bus stop or a taxi stand, a movement route to another facility (e.g., a commercial facility, etc.) different from the facility 100, or the like.

In addition, FIG. 1 illustrates a plurality of (e.g., three) the movement routes B, but the number of the movement routes B is not limited thereto, and may be two or less or four or more. Hereinafter, in some cases, the three movement routes B are referred to as “first movement route B1”, “second movement route B2”, and “third movement route B3”, but are referred to as “movement routes B”, when not particularly distinguished.

As the congestion information acquired by the information processing apparatus 10, information about a degree of congestion of each movement route B can be used. Note that the degree of congestion is an index value indicating a degree of the congestion situation on each movement route B, and the degree of congestion is represented by several levels according to the number of people on the movement route B, or the like.

Note that the congestion information is not limited to the degree of congestion described above, and may use, for example, people flow information indicating a flow of people on each movement route B, such as a moving speed of people, information about the number of people on the movement route B, or the like. Furthermore, the congestion information may include a congestion situation around the facility 100.

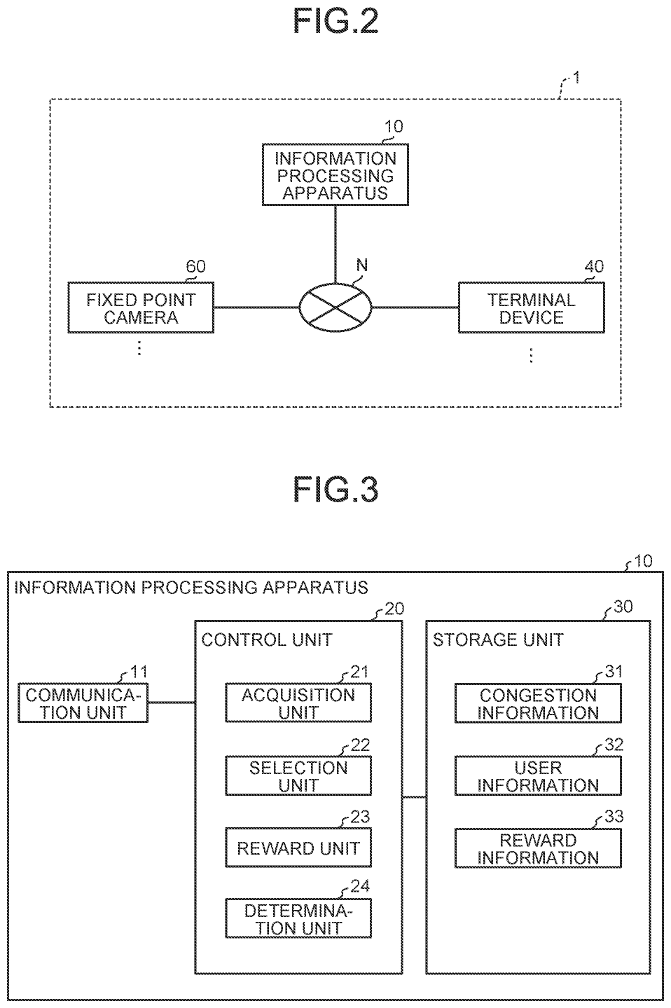

The information processing apparatus 10 acquires the congestion information described above, on the basis of, for example, position information of a terminal device 40 (see FIG. 2) of each person (hereinafter referred to as “user U”) on a movement route B or around the facility 100, a camera image of a fixed point camera 60 (see FIG. 2) installed around the movement route B and the facility 100, and the like, but the acquisition of thereof will be described later.

Next, the information processing apparatus 10 acquires user position information indicating the position of each user U (Step S2). Specifically, the information processing apparatus 10 acquires the user position information indicating the position of the user U relative to the event facility 100. “Position of the user U relative to the event facility 100” described above is, for example, a positional relationship between the user U and the event facility 100 on the basis of the event facility 100, in other words, is also a distance to the user U from the event facility 100.

Therefore, specifically, the user position information includes “information indicating that the position of the user U is around the facility 100 and has not reached a movement route B”, “information indicating that the position of the user U reaches a movement route B and the distance from the event facility 100 is relatively short”, “information indicating that the position of the user U reaches a movement route B and the distance from the event facility 100 is relatively long”, and the like.

Note that the specific user position information described above is merely an example and is not limited thereto. Furthermore, the information processing apparatus 10 may acquire an absolute position of the user U such as latitude/longitude information, and obtain information indicating the position of the user U relative to the event facility 100 on the basis of the acquired absolute position and position information of the event facility 100 stored in advance.

Next, the information processing apparatus 10 selects a target user from a plurality of the users U, on the basis of the congestion information and the user position information (Step S3). The target user means a user who is a reward target, which is described later.

Here, an example is described in which the congestion information shows that the degree of congestion on the first movement route B1 is higher than the degrees of congestion of the other second and third movement routes B2 and B3. In FIG. 1, the degree of congestion on the first movement route B1 is high. Therefore, for example, if users U0 around the facility 100 moves to the first movement route B1, the first movement route B1 will be further congested.

Therefore, on the basis of the congestion information and the user position information, the information processing apparatus 10 selects, as the target users, the users U0 each being a user U whose position is not on the first movement route B1 and whose position is around the event facility 100 and has not reached any movement route B, from the plurality of the users U.

Then, the information processing apparatus 10 provides, to the users U0 who are the target users, rewards according to the user position information of the users U0 (Step S4). For example, since the positions of the users U0 have not reached any movement route B, the information processing apparatus 10 provides the rewards (e.g., coupon etc.) related to stores 120 and 130 on movement routes B (here, the second and third movement routes B2 and B3) different from the first movement route B1.

In this way, in the present embodiment, providing the rewards to the users U0 on the basis of the congestion information and the user position information guides the users U0 to the stores 120 and 130 on the second and third movement routes B2 and B3 that are not congested. In other words, prompting the users U0 around the facility 100 to move to the second or third movement routes B2 and B3 makes it possible to suppress further congestion on the first movement route B1, thus, efficiently relieving congestion on the movement routes B.

Note that the selection of the target users and the contents of the rewards provided to the target users are not limited to the above description. In other words, for example, the information processing apparatus 10 selects, as the target users, users U1 each being a user U whose position has reached the first movement route B1 and whose distance from the event facility 100 is relatively short, from the plurality of the users U.

Then, the information processing apparatus 10 provides, to the users U1 who are the target users, the rewards according to the user position information of the users U1. For example, the information processing apparatus 10 provides the rewards related to a store 110 on the first movement route B1, since the positions of the users U1 are on the first movement route B1 that is congested, and are near the facility 100.

In this way, in the present embodiment, providing the rewards to the users U1 on the basis of the congestion information and the user position information guides the users U1 to the store 110 on the first movement route B1. Therefore, prompting the users U1 to enter and stay in the store 110 can reduce the number of people moving on the first movement route B1, efficiently relieving the congestion on the first movement route B1.

Furthermore, staying of the users U1 in the store 110 can temporally disperse the number of people moving from the first movement route B1 to the station A, more efficiently relieving the congestion on the movement routes B including the station A.

Note that a user U2 who moves on the second movement route B2 and a user U3 who moves on the third movement route B3 can also be selected as the target users, but the selection thereof will be described later.

<Configuration of Information Processing System>

Next, a configuration of the information processing system 1 including the information processing apparatus 10 according to the present embodiment will be described with reference to FIG. 2. FIG. 2 is a block diagram illustrating a configuration example of the information processing system 1.

As illustrated in FIG. 2, the information processing system 1 includes the information processing apparatus 10, the terminal device 40, and the fixed point camera 60 which are described above, and the information processing apparatus 10, the terminal device 40, and the fixed point camera 60 are communicably connected via a communication network N such as the Internet. Note that, in FIG. 2, one terminal device 40 and one fixed point camera 60 are illustrated for simplification of illustration, but a plurality of the terminal devices 40 and a plurality of the fixed point cameras 60 may be provided.

The terminal device 40 is a device held and used by the user U. Note that, the terminal device 40 can use, but is not limited to, for example, a smartphone, a tablet terminal, or the like.

The terminal device 40 includes, for example, a global positioning system (GPS) receiver or the like that detects the position information indicating the position of the user U (more precisely, the position of the terminal device 40) on the basis of a signal from a GPS satellite. The terminal device 40 is configured to transmit the detected position information to the information processing apparatus 10.

The fixed point camera 60 is installed on a movement route, in the facility, around the facility, or around a destination. Furthermore, a plurality of the fixed point cameras 60 may be installed on the movement route B. As an example, the fixed point camera 60 may be installed at a plurality of points such as a point B1a (see FIG. 1) whose distance from the event facility 100 is relatively short, a point B1b (see FIG. 1) near the middle point, and a point B1c (see FIG. 1) whose distance from the event facility 100 is relatively long, along the first movement route B1.

The fixed point camera 60 is configured to capture an image of the movement route, an image inside the facility, an image around the facility, or an image around the destination, and transmit the captured camera image to the information processing apparatus 10. Note that the camera image of the fixed point camera 60 is moving image data, but is not limited thereto, and may be still image data or the like. This camera image is acquired as the congestion information in the information processing apparatus 10, but the acquisition thereof will be described later.

Note that the fixed point camera 60 may be a human detection sensor that detects a person on the movement route, in the facility, around the facility, or around the destination. For the human detection sensor, for example, a pyroelectric sensor using an infrared signal, or the like can be adopted.

Note that, in a case where the information processing apparatus 10 acquires the congestion information on the basis of the position information of the terminal devices 40 as described above, in other words, in a case where the camera image of the fixed point camera 60 is not used as the congestion information, the fixed point camera 60 may be removed.

<Configuration of Information Processing Apparatus>

Next, a configuration of the information processing apparatus 10 will be specifically described with reference to FIG. 3 and the like. FIG. 3 is a block diagram illustrating the configuration example of the information processing apparatus 10. Note that in the block diagram of FIG. 3, only component elements necessary to describe the features of the present embodiment are illustrated in functional blocks, and descriptions of general component elements are omitted.

In other words, the component elements in the block diagram of FIG. 3 are each illustrated on the basis of a functional concept, and do not necessarily need to be configured physically as illustrated. For example, a specific form of distribution or integration of the functional blocks is not limited to the illustrated form, and all or some of the functional blocks can be functionally or physically distributed or integrated in any unit according to various loads, usage conditions, or the like.

As illustrated in FIG. 3, the information processing apparatus 10 includes a communication unit 11, a control unit 20, and a storage unit 30.

The communication unit 11 is a communication interface that is connected to the communication network N in a bidirectionally communicable manner, and the communication unit 11 transmits and receives information to and from the terminal device 40, the fixed point camera 60, and the like.

The control unit 20 includes an acquisition unit 21, a selection unit 22, a reward unit 23, and a determination unit 24, including, for example, a computer that includes a central processing unit (CPU), a read only memory (ROM), a random access memory (RAM), a hard disk drive, an input/output port, and the like, and various circuits.

The CPU of the computer reads and executes, for example, programs stored in the ROM to function as the acquisition unit 21, the selection unit 22, the reward unit 23, and the determination unit 24 of the control unit 20.

In addition, at least some or all of the acquisition unit 21, the selection unit 22, the reward unit 23, and the determination unit 24 of the control unit 20 may include hardware such as an application specific integrated circuit (ASIC) or a field programmable gate array (FPGA).

Furthermore, the storage unit 30 is a storage unit including a storage device such as a nonvolatile memory, a data flash memory, or a hard disk drive. This storage unit 30 stores congestion information 31, user information 32, reward information 33, various programs, and the like.

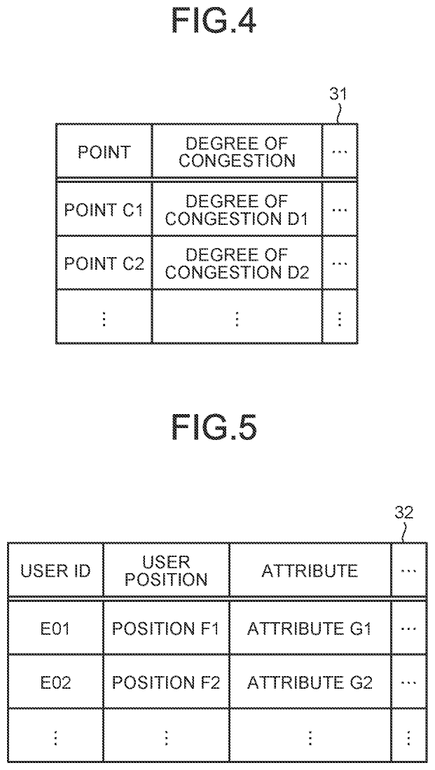

The congestion information 31 represents information indicating a congestion situation on a movement route B and a congestion situation around the facility 100. Here, the congestion information 31 will be described with reference to FIG. 4. FIG. 4 is a table illustrating an example of the congestion information 31.

As illustrated in FIG. 4, the congestion information 31 includes items such as “point” and “degree of congestion”, and the items are associated with each other.

“Point” is information indicating the movement route B and a point around the facility 100. Specifically, “point” is information indicating a movement route name such as the first movement route B1 or the second movement route B2, a point name on the movement route B such as the point B1a (see FIG. 1), a name of an entrance of the facility 100 such as an east side or a west side, and the like.

Note that, in the example illustrated in FIG. 4, “point” shows an abstract name such as “point C1”, for convenience, but specific information is stored in “point C1”. Hereinafter, other information may also be represented by an abstract name.

“Degree of congestion” is information indicating the degree of the congestion situation on the movement route B or the like, and is, for example, information represented by a level corresponding to the number of people positioned in a predetermined area including a corresponding point. The congestion information 31 may include, in addition to or instead of “degree of congestion”, the people flow information indicating a flow of people on the movement route B, such as a moving speed of people on the movement route B or the like, information about the number of people on the movement route B, or the like, as described above.

The example illustrated in FIG. 4 shows that the degree of congestion is “degree of congestion D1” at “point C1”.

Description will be made with reference to FIG. 3 again. The user information 32 represents information about each user. Here, the user information 32 will be described with reference to FIG. 5. FIG. 5 is a table illustrating an example of the user information 32.

As illustrated in FIG. 5, the user information 32 includes items such as “user ID”, “user position”, and “attribute”, and the items are associated with each other.

“User ID” is identification information for identification of each user U. “User position” indicates the position of the user U, and is specifically the user position information indicating the position of the user U relative to the facility 100.

“Attribute” is attribute information indicating an attribute of each user U. “Attribute” includes information such as the age, sex, address, hobby, and taste of the user U, but these information are merely examples, and “attribute” is not limited thereto.

In the example illustrated in FIG. 5, data about a user identified by the user ID “E01” shows that the user position is “position F1” and the attribute is “attribute G1”.

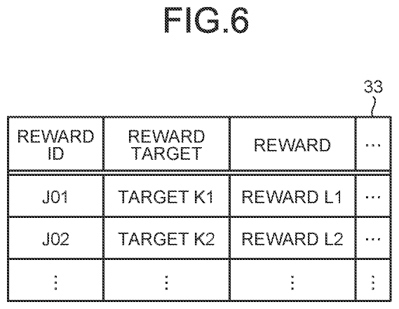

Description will be made with reference to FIG. 3 again. The reward information 33 is information about the reward such as a coupon. Here, the reward information 33 will be described with reference to FIG. 6. FIG. 6 is a table illustrating an example of the reward information 33.

As illustrated in FIG. 6, the reward information 33 includes items such as “reward ID”, “reward target”, and “reward”, and the items are associated with each other.

“Reward ID” is identification information for identification of each reward. “Reward target” is information indicating each target to which the reward is provided. For example, “reward target” includes information about each target user selected on the basis of the congestion information and the user position information, which are described above. Setting various conditions on “reward target” or setting various conditions on the reward information 33 by providing various condition items makes it possible to provide the reward to an appropriate target person according to the congestion situation, and a preferable congestion relief effect can be expected. For example, by setting conditions, such as the position of the target person, a congestion point and congestion state, the congestion situation of a reward target facility, a period of time, weather, and the congestion situations of transport facilities, enables provision of a detailed reward according to the situation.

“Reward” is information indicating the content of each reward provided to each target user. “Reward target” and “reward” described above are set on the basis of, for example, the congestion information and the user position information, but the setting thereof will be described later.

In the example illustrated in FIG. 6, the data of the reward identified by a reward ID “J01” shows that the reward target is “target K1”, and the reward is “reward L1”.

Note that “reward” may include issuance information indicating details of issuance of the rewards provided to the target users. In other words, “reward” may include information such as the content of the reward, the maximum number of the rewards issued, a range of issuing the rewards, and an available time period. “Reward” is set on the basis of, for example, the congestion information and facility information, but the setting thereof will be described later in the second embodiment.

Description will be made with reference to FIG. 3 again. The acquisition unit 21 of the control unit 20 acquires various information via the communication unit 11. For example, the acquisition unit 21 acquires the congestion information including the congestion situation on each movement route B and the congestion situation around the facility 100. For example, the acquisition unit 21 is configured to measure the number of people on the movement route B or around the facility 100 on the basis of the position information of the terminal devices 40, and register the degree of congestion according to the number of people measured, in the congestion information 31 (see FIG. 4) in the storage unit 30.

Furthermore, the acquisition unit 21 may acquire the congestion information on the basis of the camera image or the like of the fixed point camera 60 (see FIG. 2). For example, the acquisition unit 21 may analyze the camera image transmitted from the fixed point camera 60 to measure the number of people on the movement route B or around the facility 100, and register the degree of congestion according to the number of people measured, in the congestion information 31.

Furthermore, the acquisition unit 21 acquires the user position information. For example, the acquisition unit 21 acquires the position information from the terminal device 40, and detects the position of each user U relative to the facility 100, on the basis of the position information from the terminal device 40. Then, the acquisition unit 21 registers the detected position of the user U relative to the facility 100 as the user position information in the user information 32 in the storage unit 30.

Note that the user U indicated by the user position information described above can also be said to be a user whose subsequent (future) movement route B may include a congestion occurrence point (i.e., having a relatively high possibility). “User whose subsequent movement route B may include the congestion occurrence point” can also be said specifically a user who is positioned around the facility 100, and more specifically a user who is at a position nearer to the facility 100 than to the congestion occurrence point.

Furthermore, the acquisition unit 21 may acquire attribute information from the terminal device 40 and register the attribute information as the attribute information of the user information 32 in the storage unit 30.

The selection unit 22 selects the target users from the plurality of the users U on the basis of the congestion information 31, the user information 32, and the reward information 33 in the storage unit 30. Furthermore, the reward unit 23 provides the target users with the rewards according to the user position information of the target users, on the basis of the congestion information 31, the user information 32, and the reward information 33 in the storage unit 30. Therefore, the congestion on the movement routes B can be efficiently relieved.

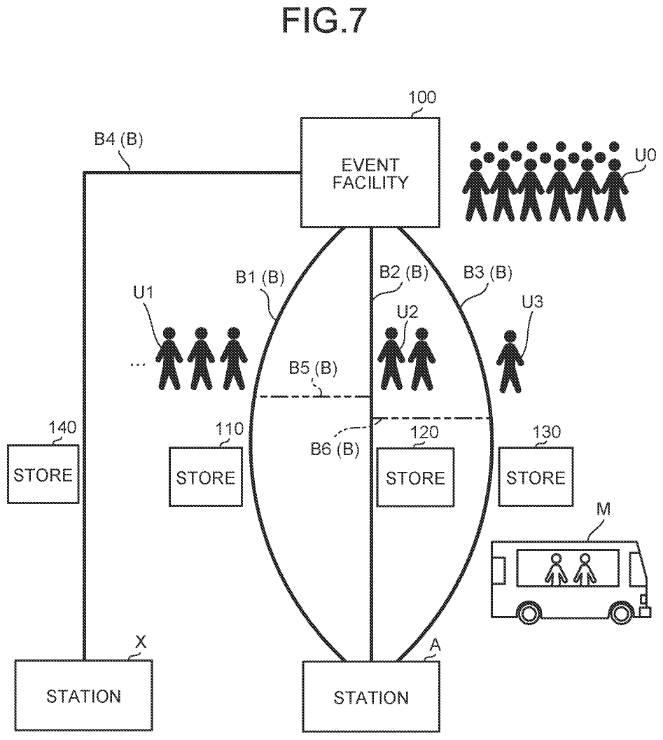

Here, selection processing in the selection unit 22, reward processing in the reward unit 23, and the like, described above, will be described in detail with reference to FIG. 7. FIG. 7 is a diagram illustrating a process performed by the selection unit 22 and the like.

Note that here, it is assumed that the degree of congestion on the first movement route B1 is higher than the degrees of congestion on the other second and third movement routes B2 and B3. In addition, it is assumed that the degree of congestion on the second movement route B2 is higher than the degree of congestion on the third movement route B3. Furthermore, it is assumed that as the movement routes B from the facility 100, there is a movement route B4 (hereinafter referred to as “fourth movement routes B4”) to a station X different from the station A, in addition to the first to third movement routes B1 to B3.

As illustrated in FIG. 7, when the congestion information includes a congestion situation indicating the congestion on the first movement route B1 of the plurality of the movement routes B, the selection unit 22 selects, as the target users, the users U0 whose positions indicated by the user position information are around the facility 100.

Then, the reward unit 23 provides the target users with the rewards for the stores 120 and 130 on the movement routes B different from the first movement route B1, that is, the second and third movement routes B2 and B3, from among the plurality of movement routes B, according to the user position information of the target users.

In this way, the users U0 are guided to the stores 120 and 130 on the second and third movement routes B2 and B3 that are not congested compared with the store on the first movement route B1. In other words, the users U0 around the facility 100 are prompted to move to the second and third movement routes B2 and B3, and the users U are dispersed. This configuration makes it possible to inhibit the users U0 from moving to the first movement route B1 that is relatively congested and the first movement route B1 from being further congested, thus efficiently relieving the congestion on the movement routes B.

Note that an example of the reward described above includes the coupon that can be used in the store (here, the stores 120 and 130), but the reward is not limited thereto, and another type of reward such as points that can be used in the store may be used. In addition, the reward described above, such as the coupon and points, can be used for, for example, payment at the store, but is not limited thereto, and may be used for a service and the like.

Furthermore, in the above description, the reward for the stores 120 and 130 on the second and third movement routes B2 and B3 are provided, but at this time, the reward unit 23 may make the content of the reward different between the store 120 and the store 130. In other words, for example, the reward unit 23 may make the content of the reward different on the basis of the congestion information. Specifically, the reward unit 23 may provide the reward so that the content of the reward for the store 130 on the third movement route B3 that is not congested as compared with the second movement route B2 is better than the content of the reward for the store 120 on the second movement route B2.

This configuration makes it possible to prompt the users U0 around the facility 100 to move to the third movement route B3 that is less congested than the first and second movement routes B1 and B2. Therefore, it is possible to equalize the congestion on the first to third movement routes B1 to B3, and thus it is possible to efficiently relieve the congestion on the movement routes B.

Furthermore, the users U0 who are the target users have not reached any movement route B, and therefore, the reward unit 23 may provide the users U0 with the rewards for a store 140 on the fourth movement route B4. In other words, the reward unit 23 may provide the reward for the store 140 on the fourth movement routes B4 to the station X (second predetermined point) different from the station A, on the basis of the congestion information. Specifically, when the congestion information includes information indicating that there is a movement route B (here, the first movement route B1) having a high degree of congestion, the reward unit 23 may provide the reward for the store 140 on the fourth movement route B4.

This configuration makes it possible to prompt the users U0 around the facility 100 to move to the fourth movement routes B4, thus, efficiently relieving the congestion on the first to third movement routes B1 to B3.

Furthermore, the selection unit 22 may select the users U1 as the target users from the plurality of the users U. In other words, when the congestion information includes the congestion situation indicating the congestion on the first movement route B1 of the plurality of the movement routes B, the selection unit 22 selects, as the target users, the users U1 whose positions indicated by the user position information are on the first movement route B1.

Then, the reward unit 23 provides the target users with the rewards for the store 110 on the first movement route B1, according to the user position information of the target users.

In this manner, the users U1 are guided to the store 110 on the first movement route B1, and are prompted to enter and stay in the store 110. Therefore, the number of people moving on the first movement route B1 can be reduced, and the congestion on the first movement route B1 can be efficiently relieved. Furthermore, temporary staying of the users U1 in the store 110 can temporally disperse the number of people moving on the first movement route B1 toward the station A, and the congestion on the movement routes B including the station A can be relieved more efficiently.

Note that, in the above description, the reward unit 23 provides the rewards for the store 110 on the first movement route B1 to the users U1 who are the target users, but the rewards are not limited thereto, and the rewards for the stores 120 and 130 on the second and third movement routes B2 and B3 may be provided.

In an example, as represented by an imaginary line in FIG. 7, in a case where there are a fifth movement route (connecting route) B5 that connects between the first movement route B1 and the second movement route B2 and a sixth movement route (connecting route) B6 that connects between the second movement route B2 and the third movement route B3, the reward unit 23 may provide the rewards for the stores 120 and 130 on the second and third movement routes B2 and B3, to the users U1 who are the target users. In other words, the reward unit 23 may provide the users U1 with the rewards for the stores 120 and 130 on the second and third movement routes B2 and B3 in order to avoid movement on the first movement route B1 that is relatively congested.

In this way, the users U1 may be guided to the stores 120 and 130 on the second and third movement routes B2 and B3 to reduce the number of people moving on the first movement route B1. Therefore, the congestion on the first movement route B1 can be efficiently relieved.

Furthermore, the selection unit 22 may select the users U2 and U3 as the target users from the plurality of the users U. In other words, when the congestion information includes the congestion situation indicating the congestion on the first movement route B1 of the plurality of the movement routes B, the selection unit 22 selects, as the target users, the users U2 and U3 whose positions indicated by the user position information are on the movement routes B different from the first movement route B1, that is, the second and third movement routes B2 and B3.

Then, the reward unit 23 provides the target users (users U2 and U3) with the rewards for the stores 120 and 130 on the movement routes B different from the first movement route B1, that is, the second and third movement routes B2 and B3, according to the user position information of the target users.

In this way, the users U2 and U3 are guided to the stores 120 and 130 on the second and third movement routes B2 and B3, and are prompted to enter and stay in the stores 120 and 130. Therefore, temporary staying of the users U2 and U3 in the stores 120 and 130 can temporally disperse the number of people moving on the second and third movement routes B2 and B3 toward the station A, and priority is given to people moving on the first movement route B1 toward the station A. Therefore, the congestion on the movement routes B including the station A can be more efficiently relieved. In addition, the number of people moving on the second and third movement routes B2 and B3 can be reduced, and the congestion on the second and third movement routes B2 and B3 can be efficiently relieved.

Furthermore, the reward unit 23 may provide the reward according to store type, such as the stores 110, 120, and 130. Specifically, the stores such as the stores 110, 120, and 130 are different in, for example, store type and store use method. Examples of the store type include a type of store where people enter and stay (a store for eating and drinking) and a type of store that merely attracts people (a take-out restaurant and a distributor such as a gift shop). In addition, as an example of the store use method, the type of store where people enter and stay tends to lead to a use method requiring a relatively long staying time but the type of store that merely attracts people tends to lead to a use method requiring a relatively short staying time. Therefore, the reward information 33 (see FIG. 6) may include information about the reward target (target user) associated with the store type or the store use method, or information indicating the content of the reward associated with the store type or the store use method. Then, the reward unit 23 provides the rewards to the target users on the basis of the reward information 33 and the like.

For example, when the degree of congestion on the movement routes B is relatively high, the reward unit 23 may provide the reward for a type of store where the users enter and stay and a relatively long staying time is required. This configuration makes it possible to prompt the users U on the movement routes B to enter the store and stay in the store for a relatively long time, thus efficiently relieving the congestion on the movement routes B.

Furthermore, when the degree of congestion on each movement route B is relatively low, the reward unit 23 may provide the reward for a type of store that merely attracts people and a relatively short staying time is required. This configuration makes it possible to prompt the users U on the movement route B to enter the store and stay in the store for a relatively short time, thus efficiently relieving the congestion on the movement route B.

In this way, using store type information makes it possible to select an appropriate target user according to, for example, the store type or the store use method, or to provide an appropriate reward according to the store type or the store use method.

Furthermore, the reward unit 23 may read the attribute information of the user information 32 in the storage unit 30 and provide the target users with the rewards according to the attribute information. For example, the reward unit 23 may provide the rewards to the target users according to the attributes of the users U (e.g., age, sex, hobby, etc.). This configuration make it possible to provide the rewards appropriate for the users U who are the target users, effectively guiding the users U to the corresponding store or the like.

Note that in the above description, the information about the movement routes B is obtained from the user position information, but the present invention is not limited thereto. In other words, for example, the information processing apparatus 10 may be configured to predict (estimate) the movement route B on the basis of information stored in the terminal device 40.

In an example, it is assumed that the terminal device 40 stores, as the attribute information, information about a user's outward way (e.g., information about a route taken by the user on the way to the facility 100), home information including position information of the user's home, and the like. At this time, the acquisition unit 21 acquires the attribute information from the terminal device 40 and registers the acquired attribute information as the attribute information of the user information 32 (see FIG. 5).

Subsequently, the acquisition unit 21 may predict the movement route B that is a user's return way, for example, by calculating the information about the user's outward way included in the attribute information backward. In addition, the acquisition unit 21 may predict some or all of roads from the facility 100 to the position of the home as the movement routes B, on the basis of, for example, the home information included in the attribute information. Then, the selection unit 22 may select the target user from the plurality of the users U, on the basis of the predicted movement route B or the like. This configuration makes it possible to select an appropriate target user according to user's attribute information (the information about the user's outward way, the home information, etc.).

The determination unit 24 determines an installation position of a mobile store M on the basis of the congestion information. The mobile store M is a movable store. For the mobile store M, a food stand, a food truck, or the like can be used, but the mobile store M is not limited thereto as long as the mobile store is a movable store.

For example, when the congestion information includes the congestion situation indicating the congestion on the first movement route B1 of the plurality of the movement routes B, the determination unit 24 determines, as the installation position of the mobile store M, a position on the movement routes B different from the first movement route B1, that is, a position on the second and third movement routes B2 and B3, from among the plurality of movement routes B.

The determination unit 24 notifies the mobile store M (or a manager of the mobile store M) of information about the determined installation position. Therefore, the mobile store M is moved to and installed at the installation position. Note that FIG. 7 illustrates an example in which the determination unit 24 has determined a position on the third movement route B3 as the installation position of the mobile store M.

Furthermore, the reward unit 23 is configured to provide the target users with the rewards for the mobile store M for which the installation position has been determined by the determination unit 24.

In this way, moving and installing the mobile store M on the basis of the congestion information guides the users U to the third movement route B3 that is less congested than the first movement route B1. In other words, prompting the users U to move to the third movement route B3 disperses the users U. Therefore, it is possible to equalize the congestion, for example, on the first to third movement routes B1 to B3, and thus it is possible to efficiently relieve the congestion on the movement routes B.

In addition, installation of the mobile store M makes the user U3 moving on the third movement route B3 to readily stay temporarily at the mobile store M. Therefore, the number of people moving on the third movement route B3 toward the station A can be temporally dispersed, and priority is given to people moving on the first movement route B1 toward the station A. Therefore, the congestion on the movement routes B including the station A can be more efficiently relieved. In addition, the number of people moving on the third movement route B3 can be reduced, and a congestion on the third movement route B3 can be efficiently relieved.

Furthermore, in a case where the installation position of the mobile store M is determined by the determination unit 24, the reward unit 23 may provide the reward such as a coupon for the mobile store M. At this time, the users U selected as the target users by the selection unit 22 are the user U0 around the facility 100 and the user U3 moving on the third movement route B3, but are not limited thereto, and may be the user U1 and the user U2.

In this way, providing the rewards for the mobile store M makes it possible to effectively guide the target users to the mobile store M.

<Control Processing in Information Processing Apparatus>

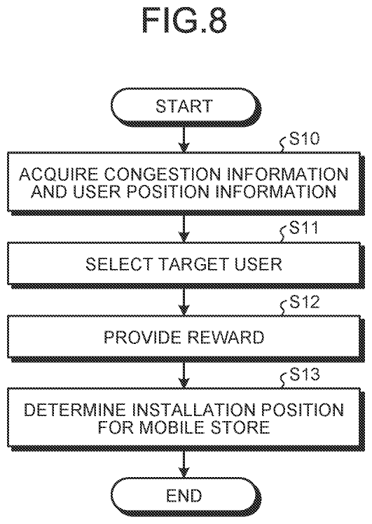

Next, an example of a specific processing procedure in the information processing apparatus 10 will be described with reference to FIG. 8. FIG. 8 is a flowchart illustrating the process procedure performed by the information processing apparatus 10.

As illustrated in FIG. 8, the control unit 20 of the information processing apparatus 10 acquires the congestion information including the congestion situation on the movement routes B and the user position information indicating the position of the user U relative to the facility 100 (Step S10). Next, the control unit 20 selects the target user from the plurality of the users U, on the basis of the congestion information and the user position information (Step S11).

Next, the control unit 20 provides the selected target user with the reward according to the user position information of the target user (Step S12). Next, the control unit 20 determines the installation position of the mobile store M, on the basis of the congestion information (Step S13).

Note that, in the example of FIG. 8, the processing of Step S13 is performed last, but is not limited thereto. In other words, the processing of Step S13 may be performed before Steps S11 and S12, or may be performed in parallel with Steps S11 and S12.

As described above, the information processing apparatus 10 according to the first embodiment includes the acquisition unit 21, the selection unit 22, and the reward unit 23. The acquisition unit 21 acquires the congestion information including the congestion situation on the movement routes B extending from the event facility 100 to the predetermined point (station A), and the user position information indicating the position of the user U. The selection unit 22 selects the target user from the plurality of the users U, on the basis of the congestion information and the user position information acquired by the acquisition unit 21. The reward unit 23 provides the target user selected by the selection unit 22, with the reward according to the user position information of the target user. Therefore, the congestion on the movement routes B from the event facility 100 can be efficiently relieved.

### Second Embodiment

<Overview of Information Processing Method>

Next, an overview of an information processing method according to the second embodiment will be described. Note that in the second embodiment, a description the same as that of the first embodiment may be partially omitted. FIGS. 9 to 11 are diagrams illustrating an overview of the information processing method according to the second embodiment. The information processing method according to the second embodiment is performed by the information processing apparatus 10 (see FIG. 2). The information processing apparatus 10 is configured as, for example, a server device that is capable of communicating with the terminal device 40 of a user.

In the information processing method according to the second embodiment, congestion information about a movement route of the user to a destination and situations of facilities (stores A and B) where a reward such as a coupon can be used are grasped in real time, and the reward issued to the user is dynamically changed to guide the user to the facilities, thereby relieving congestion.

Note that the destination is, for example, a specific-purpose facility, such as a transport facility station including a station, a bus stop, or a taxi stand, or an event facility (sports facility, concert venue, or the like) in which a predetermined event is held, but is not limited thereto, and may be a mere position, such as a road, an intersection, or the like.

Furthermore, the facility where the reward can be used includes, for example, a restaurant or a shopping mall, but may include, for example, a transport facility station such as a station, a bus stop, or a taxi stand. In addition, the reward includes, for example, a coupon such as a discount ticket, a point corresponding to a cash voucher, predetermined service provided by the facility, or the like.

In the information processing method according to the second embodiment, the congestion information indicating a congestion situation on the movement routes and facility information indicating the situations of the facilities (stores A and B) are acquired first. For example, the congestion information includes information indicating a degree of congestion showing how the movement route is crowded. Furthermore, the facility information includes information about the degree of congestion in the facility, a reward use record of the rewards having used in the facility, and the like. Note that details of the congestion information and the facility information will be described later.

In a situation illustrated in FIG. 9, it is assumed that the congestion information about the movement routes to the destination is acquired in which a movement route (solid line) going by the store A is relatively less congested, and movement routes (broken lines) other than the movement route going by the store A are congested. Furthermore, in the situation illustrated in FIG. 9, it is assumed that the facility information indicating that the store A is not congested and the store B is congested is acquired.

In such a case, in the information processing method according to the second embodiment, the movement route (solid line) relatively less congested is presented as a recommended route to a user, on the basis of the congestion information. At this time, in order to guide the user to the recommended route, the reward for the store A located on this movement route is issued to the user. This configuration makes it possible to guide the user along the movement route (solid line) less congested, avoiding the congested movement routes (broken lines).

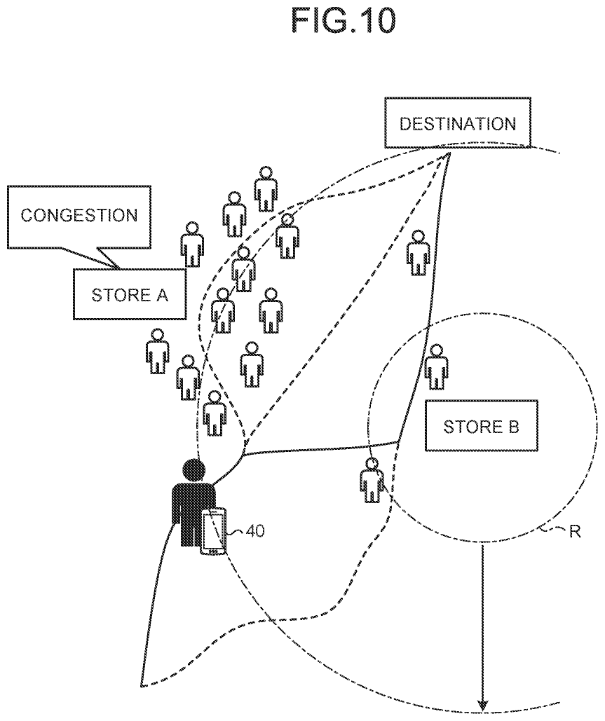

Furthermore, at this time, in the information processing method according to the embodiment, the content of the reward that can be used in the store A that is not congested is upgraded (higher discount rate) than in the store B that is congested. In other words, in the information processing method according to the embodiment, issuance information about details of issuance of the reward (e.g., discount rate, etc.) for the store A is determined for the guide to the movement route and store A that are less congested, on the basis of the congestion information and the facility information. Note that the issuance information includes a range R of issuing the rewards (see FIG. 10), reward available time period, and the like, in addition to the content of the reward such as the discount rate.

Alternatively, the content of the reward for the store B that is congested may be downgraded (lower discount rate), for the guide to the store A that is less congested.

Subsequently, as illustrated in FIG. 10, it is assumed that the facility information showing that the store A is congested and the congestion information showing that the movement route going by the store A is congested are acquired while the user holding the terminal device 40 is moving toward the store A. In such a case, in the information processing method, the details of issuance of the reward is changed so as to guide the user to the store B, avoiding the store A, on the basis of the acquired facility information and congestion information.

Specifically, as illustrated in FIG. 10, in the information processing method according to the second embodiment, the issuance information is changed so as to expand the range R of issuing the rewards for the store B. At this time, the content of the reward for the store B may be matched with that of the reward for the store A.

Therefore, a new reward for the store B is issued to the terminal device 40 of the user, making it easier for the user and other users to change the movement routes and to be guided to the store B. Thus, it is possible to relieve the congestion in the store A and congestion on the movement route going by the store A.

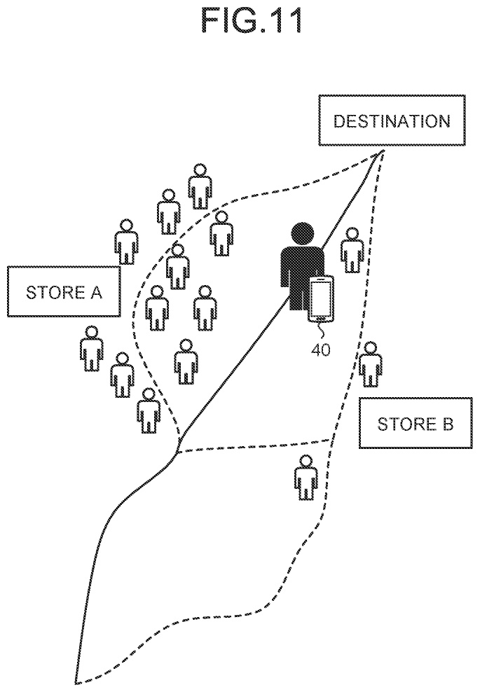

Subsequently, as illustrated in FIG. 11, it is assumed that the user to whom the reward for the store B has been issued moves to the destination without moving on the movement route going by the store B. In such a case, in the information processing method, it is determined that the user is less likely to use the reward for the store B, and the rewards are newly issued to a terminal devices 40 of the other users (e.g., users near the store A).

In this way, predicting users' likelihood of use of the rewards and newly issuing the rewards to users having a likelihood of use of the rewards (users near the store B, users trying to use the reward in the store A congested, etc.), instead of issuing the reward to the user having no likelihood of use of the reward makes it possible to improve the reward use record of the store B.

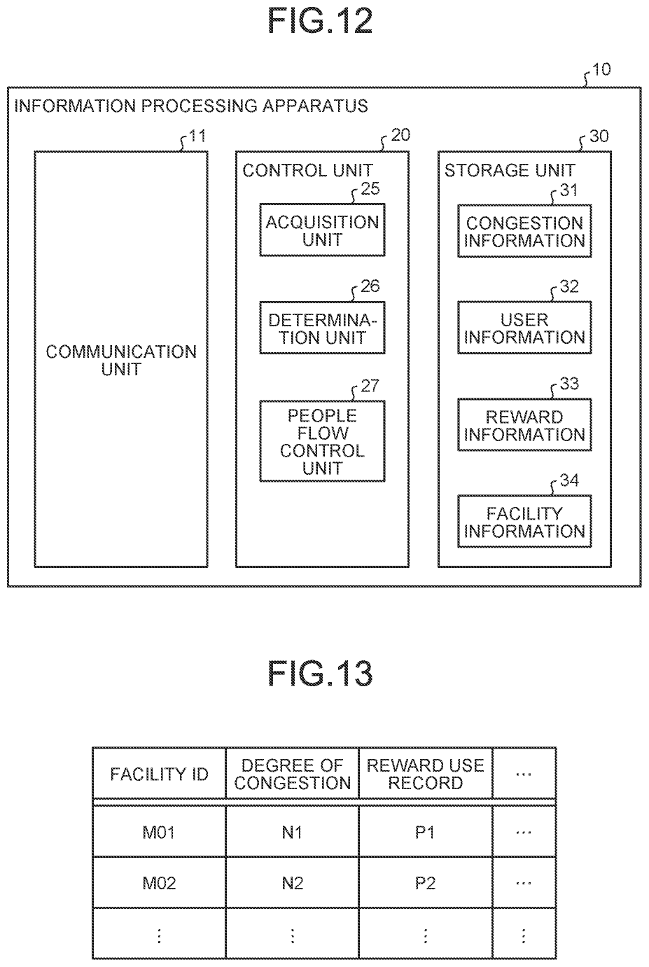

Next, a configuration of the information processing apparatus 10 will be specifically described with reference to FIG. 12 and the like. FIG. 12 is a block diagram illustrating a configuration example of the information processing apparatus 10. Note that in the block diagram of FIG. 12, only component elements necessary to describe the features of the present embodiment are illustrated in functional blocks, and descriptions of general component elements are omitted.

In other words, the component elements in the block diagram of FIG. 12 are each illustrated on the basis of a functional concept, and do not necessarily need to be configured physically as illustrated. For example, a specific form of distribution or integration of the functional blocks is not limited to the illustrated form, and all or some of the functional blocks can be functionally or physically distributed or integrated in any unit according to various loads, usage conditions, or the like.

As illustrated in FIG. 12, the information processing apparatus 10 includes the communication unit 11, the control unit 20, and the storage unit 30.

The communication unit 11 is a communication interface that is connected to the communication network N in a bidirectionally communicable manner, and the communication unit 11 transmits and receives information to and from the terminal device 40, the fixed point camera 60, and the like.

The control unit 20 includes an acquisition unit 25, a determination unit 26, and a people flow control unit 27, including, for example, a computer that includes a central processing unit (CPU), a read only memory (ROM), a random access memory (RAM), a hard disk drive, an input/output port, and the like, and various circuits.

The CPU of the computer reads and executes, for example, programs stored in the ROM to function as the acquisition unit 25, the determination unit 26, and the people flow control unit 27 of the control unit 20.

In addition, at least some or all of the acquisition unit 25, determination unit 26, and people flow control unit 27 of the control unit 20 may include hardware such as an application specific integrated circuit (ASIC) or a field programmable gate array (FPGA).

Furthermore, the storage unit 30 is a storage unit including a storage device such as a nonvolatile memory, a data flash memory, or a hard disk drive. This storage unit 30 stores congestion information 31, user information 32, reward information 33, facility information 34, various programs, and the like.

Note that the congestion information 31, the user information 32, and the reward information 33 are similar to those of the first embodiment, and the description thereof will be omitted.

The facility information 34 is information about a situation of each facility where the reward can be used. Here, the facility information 34 will be described with reference to FIG. 13. FIG. 13 is a table illustrating an example of the facility information 34.

As illustrated in FIG. 13, the facility information 34 includes items such as “facility ID”, “degree of congestion”, and “reward use record”, and the items are associated with each other.

“Facility ID” is identification information for identification of each facility. “Degree of congestion” is information indicating a degree of the congestion situation in and around each facility, and is, for example, information represented by a level corresponding to the number of people in the facility and in a predetermined area including the position of the facility. “Reward use record” is information indicating the reward use record during a certain period, and can be represented as, for example, the number of rewards used with respect to a total number of rewards issued. Note that “reward use record” can be represented in periods, that is, every hour, every day, every week, and every month.

The example illustrated in FIG. 13 shows that the degree of congestion in the facility identified by the facility ID “M01” is “N1” and the reward use record is “P1”.

Next, referring back to FIG. 12, the functions (acquisition unit 25, determination unit 26, and people flow control unit 27) of the control unit 20 will be described.

The acquisition unit 25 acquires various information via the communication unit 11. For example, the acquisition unit 25 acquires the congestion information indicating a congestion situation on the movement route. For example, the acquisition unit 25 is configured to measure the number of people around the movement route on the basis of the position information of the terminal devices 40, and register the degree of congestion according to the number of people measured, in the congestion information 31 (see FIG. 4) in the storage unit 30.

Furthermore, the acquisition unit 25 may acquire the congestion information on the basis of a camera image of the fixed point camera 60 (see FIG. 2), or the like. For example, the acquisition unit 25 may analyze the camera image transmitted from the fixed point camera 60 to measure the number of people around the movement route, and register the degree of congestion according to the number of people measured, in the congestion information 31.

Note that the congestion information acquired by the acquisition unit 25 is not limited to a current congestion situation, but may be a congestion situation a predetermined time later. For example, the acquisition unit 25 may predict the congestion situation a predetermined time later, from the above-described people flow information about users and the current congestion situation (e.g., predict the congestion situation on the downstream side the predetermined time later, from the current congestion situation on the upstream side of the people flow, the speed of people flow, and a difference in distance), and register the predicted congestion situation in the congestion information 31.

In addition, the acquisition unit 25 acquires the facility information indicating the situation of each facility. For example, the acquisition unit 25 is configured to measure the number of people in each facility on the basis of the position information of the terminal devices 40, and register the degree of congestion according to the number of people measured, in the facility information 34 (see FIG. 12) in the storage unit 30.

Furthermore, the acquisition unit 25 may acquire the facility information indicating the degree of congestion in the facility on the basis of the camera image of the fixed point camera 60 (see FIG. 2), or the like. For example, the acquisition unit 25 may analyze the camera image transmitted from the fixed point camera 60 installed in the facility to measure the number of people in the facility, and register the degree of congestion according to the number of people measured, in the facility information 34.

Note that the congestion situation of the facility acquired by the acquisition unit 25 is not limited to a current congestion situation, but may be a congestion situation a predetermined time later. For example, the acquisition unit 25 may predict the congestion situation of the facility the predetermined time later, from the above-described people flow information about users and the current congestion situation of the facility, and register the predicted congestion situation in the facility information 34.

Furthermore, the acquisition unit 25 acquires information about the reward use record as the situation of the facility. For example, the acquisition unit 25 receiving information indicating the use of the reward transmitted to the terminal device 40 is configured to register the information, in the facility information 34. Alternatively, the acquisition unit 25 may receive information indicating the use of the reward, from a terminal device, not illustrated, installed in the facility and register the information in the facility information 34.

Furthermore, the acquisition unit 25 acquires the position information of each user. For example, the acquisition unit 25 acquires the position information from the terminal device 40, and detects the position of the user on the basis of the position information of the terminal device 40. Then, the acquisition unit 25 registers the detected position of the user, in the user information 32 in the storage unit 30. Note that the position of the user may be represented by a distance to a facility where the reward can be used or a distance to the destination.

The determination unit 26 determines the issuance information about the details of issuance of the reward that can be used in each facility, on the basis of the congestion information and the facility information that are acquired by the acquisition unit 25. For example, the determination unit 26 determines (changes) at least one of the content of the reward, the maximum number of the rewards issued, the range of issuing the rewards, and the reward available time period.

For example, when the facility is congested (when the degree of congestion is a predetermined value or more), the determination unit 26 changes the details of issuance of the reward for the facility, on the basis of the congestion situation of the facility. For example, when the facility is currently congested, the determination unit 26 changes the available time period. Specifically, the determination unit 26 predicts the time from which congestion is relieved, and changes the available time period to start from the predicted time.

Furthermore, when the congestion in the facility is predicted after a predetermined time, the determination unit 26 determines, as the available time period, a period of time excluding a period of time from after the predetermined time. In this way, changing the available time period to a time period excluding a congestion time period of the facility, the congestion situation of the facility can be relieved. Note that the determination unit 26 may change the length of the available time period. For example, the determination unit 26 reduces the length of the available time period when the facility is congested, and increases the length of the available time period when the facility is not congested.

Furthermore, when the facility is congested, the determination unit 26 may reduce the maximum number of the rewards issued or narrow the range of issuing the rewards. Alternatively, when the facility is congested, the determination unit 26 may change the issuance information about a facility that is not congested. For example, the determination unit 26 may upgrade the content of the reward for the facility that is not congested, increase the maximum number of the rewards issued, or expand the range of issuing the rewards.

The congestion situation of the facility may include information about a stock quantity of products related to the reward or the number of services that can be provided. In other words, in a case where the stock quantity of products or the number of services that can be provided is insufficient to the number of rewards unused, the determination unit 26 may determine that the facility is congested and change the issuance information described above.

Furthermore, in a case where the reward use record in the facility does not satisfy a predetermined condition, the determination unit 26 changes the details of issuance of the reward for the facility. For example, in a case where the reward use record is less than a use record expected (set) by the facility, the determination unit 26 changes the details of issuance so as to increase the use record.

For example, the determination unit 26 upgrades (higher discount rate) the content of the reward for a facility whose use record does not satisfy a predetermined condition, increases the maximum number of the rewards issued, or expand the range of issuing the rewards.

Furthermore, in a case where the use record is equal to or more than a predetermined value, that is, the reward is used more than expected, the determination unit 26 may downgrade the content of the reward (lower discount rate), reduce the maximum number of the rewards issued, or narrow the range of issuing the rewards, preventing the use record from being too high relative to a value expected by the facility.

In addition, in a case where there are a plurality of affiliated facilities (branch, etc.) on the movement route, the determination unit 26 may adjust the reward between the facilities according to the congestion situation of or the use record in each facility. For example, the determination unit 26 may make the reward for a facility congested available for a facility not congested, among the affiliated facilities (branch, etc.).

In this way, changing the details of issuance of the rewards on the basis of the reward use record makes it possible to guide the users to the facility highly accurately, thus, efficiently relieving the congestion.

As described above, changing, as the issuance information, the content of the reward, the maximum number of the rewards issued, the range of issuing the rewards, and the available time period by the determination unit 26 makes it possible to guide the users to the facility highly accurately, thus, efficiently relieving congestion.

The people flow control unit 27 issues the rewards, based on the issuance information determined by the determination unit 26, to the users, and performs people flow control to relieve the congestion situation. Specifically, firstly, the people flow control unit 27 determines the recommended route to be presented to each user, prior to issuance of the reward. Specifically, firstly, the people flow control unit 27 determines a movement route that is not congested, as the recommended route, on the basis of the congestion information acquired by acquisition unit 25.

Subsequently, the people flow control unit 27 determines the rewards issued to the users, on the basis of the determined recommended route and the issuance information. Specifically, when the recommended route passes through the range of issuing the rewards of the issuance information, the people flow control unit 27 issues the reward having the content of the reward according to the issuance information. Note that, when a predicted passage time in the facility and the available time period are different by a predetermined time or more, the reward is less likely to be used, and thus, the people flow control unit 27 may prohibit the issuance of the reward.

Furthermore, the people flow control unit 27 may issue the rewards to users positioned within the range of issuing the rewards, regardless of the recommended route.

Furthermore, when the number of users who use the rewards is equal to or more than the maximum number of the rewards issued, the people flow control unit 27 preferentially issues the rewards to users who are near the facility, users who will travel on a movement route congested, and users whose expected values (likelihood of use) for use of the rewards are equal to or more than a predetermined value.

The expected value can be calculated by, for example, a model trained by machine learning. For example, the expected value can be calculated using a model generated by machine learning with presence or absence of past use of the rewards by each user, frequency of use, the type of the reward used, the attribute information about the user, and the like as explanatory variables, and with the expected value as an objective variables.

For example, when there are users whose expected values are each less than a predetermined value (less likely to use the rewards) and whose number is equal to or more than a predetermined number, the people flow control unit 27 may issue the rewards whose number is equal to or more than the maximum number of the rewards issued. Thus, it is possible to avoid a reduction in reward use record highly accurately.

Furthermore, the people flow control unit 27 determines, on the basis of a user's behavior, whether that the user intends to use the issued reward, and when the user does not intend to use the reward, the people flow control unit 27 may issue the reward having been issued to the user, to other users.

For example, when the user is moving on a movement route not going by the facility where the reward can be used, the people flow control unit 27 determines that the user does not intend to use the reward, on the basis of the position information of the user, and issues the rewards to the other users.

Furthermore, for example, when another reward has already been used on the recommended route, the people flow control unit 27 may determine that the user does not intend to use the reward for the facility of the same category (e.g., restaurant). Therefore, users who are less likely to use the rewards can be excluded, and the rewards can be efficiently issued to users who are likely (considered) to use the rewards, thus, the reduction in the reward use record in the facility can be avoided.

Note that adding the presence or absence of the intention to use the reward, to the explanatory variables for the expected value, described above, makes it possible to calculate the expected value with higher accuracy.

Note that the operation of the control unit 2 related to the provision of the reward can be implemented by processing using tables using the above-described various states and various information as parameters, artificial intelligence that has learned both of past data about various states and various information and the contents of the rewards and data of the rewards actually provided, and the like.

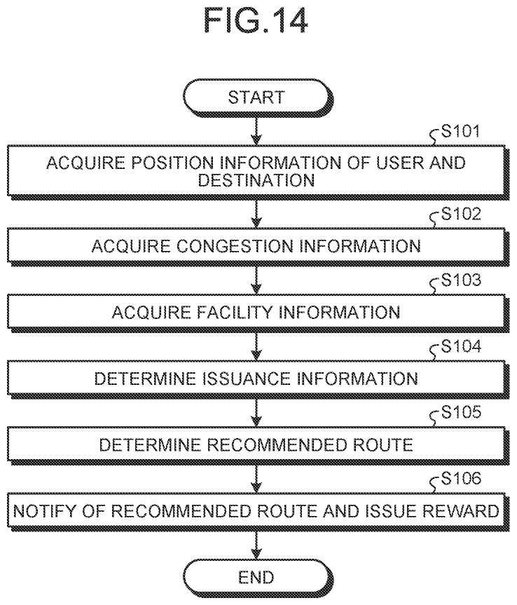

Next, a procedure of a process performed in the information processing apparatus 10 according to the second embodiment will be described with reference to FIG. 14. FIG. 14 is a flowchart illustrating the procedure of the process performed by the information processing apparatus 10 according to the second embodiment.

As illustrated in FIG. 14, the acquisition unit 25 acquires the position information of each user and the destination information (Step S101). Then, the acquisition unit 25 acquires the congestion information indicating the congestion situation between the position of the user and the destination (Step S102).

Next, the acquisition unit 25 acquires the facility information indicating the situation of each facility located between the position of the user and the destination (Step S103). Then, the determination unit 26 determines the issuance information about the details of issuance of the reward that can be used in the facility, on the basis of the congestion information and the facility information (Step S104).

Subsequently, the determination unit 26 determines, as the recommended route, a movement route to be recommended on the basis of the congestion information, that is, the movement route that is not congested (Step S105). Then, the people flow control unit 27 notifies of the determined recommended route, issues the reward based on the issuance information (Step S106), and finishes the process.

As described above, the information processing apparatus 10 according to the second embodiment includes the acquisition unit 25, the determination unit 26, and the people flow control unit 27. The acquisition unit 25 acquires the congestion information indicating the congestion situation on a movement route of a user to the destination, and the facility information indicating the situation of a predetermined facility. The determination unit 26 determines the issuance information about the details of issuance of the reward that can be used in the predetermined facility, on the basis of the congestion information and the facility information that are acquired by the acquisition unit 25. The people flow control unit 27 issues the rewards to the users, on the basis of the issuance information determined by the determination unit 26, and performs people flow control to relieve the congestion situation. Therefore, the congestion on the movement route can be efficiently relieved.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

### REFERENCE SIGNS LIST

1 Information processing system
10 Information processing apparatus
11 Communication unit
20 Control unit
21, 25 Acquisition unit
22 Selection unit
23 Reward unit
24, 26 Determination unit
27 People flow control unit
30 Storage unit
31 Congestion information
32 User information
33 Reward information
34 Facility information
40 Terminal device
60 Fixed point camera

1-13. (canceled)

14. An information processing apparatus comprising:
a processor programmed to:
acquire congestion information and user position information, the congestion information including a congestion situation on a movement route from an event facility to a predetermined point, the user position information indicating a position of a user;
in accordance with a type of a store on the movement route or a use method of the store, select a target user from a plurality of the users based on the acquired congestion information and the acquired user position information; and
provide the selected target user with a reward that is according to the type or the use method of the store, in accordance with the user position information of the target user.

15. The information processing apparatus according to claim 14, wherein
the movement route includes a plurality of the movement routes,
the processor is further programmed to:
when the congestion information includes a congestion situation indicating a congestion on some of the movement routes of the plurality of the movement routes, select the user whose position indicated by the user position information is around the event facility, as the target user, and
provide the target user with the reward for a store on the movement route different from the some of the movement routes, of the plurality of movement routes, according to the user position information of the target user.

16. The information processing apparatus according to claim 14, wherein
the movement route includes a plurality of the movement routes,
the processor is further programmed to:
when the congestion information includes a congestion situation indicating a congestion on some of the movement routes of the plurality of the movement routes, select the users whose positions indicated by the user position information are on the some of the movement routes, as the target users, and
provide the target users with the rewards for stores on the some of the movement routes, according to the user position information of the target users.

17. The information processing apparatus according to claim 14, wherein
the movement route includes a plurality of the movement routes,
the processor is further programmed to:
when the congestion information includes a congestion situation indicating a congestion on some of the movement routes of the plurality of the movement routes, select the user whose position indicated by the user position information is on the movement route different from the some of the movement routes, as the target user, and
provide the target user with the reward for a store on the movement route different from the some of the movement routes, according to the user position information of the target user.

18. The information processing apparatus according to claim 14 wherein
the processor is further programmed to:
determine an installation position of a movable mobile store, based on the congestion information.

19. An information processing apparatus comprising:
a processor programmed to:
acquire congestion information and facility information, the congestion information indicating a congestion situation on a movement route of a user to a destination, the facility information indicating a situation of a predetermined facility, the predetermined facility including a store on the movement route;
determine issuance information about details of issuance of a reward that is according to a type or a use method of the store and is usable in the predetermined facility, based on the acquired congestion information and the acquired facility information; and
issuing the reward based on the determined issuance information to the user that is selected in accordance with the type of the store or the use method of the store of the user, and perform people flow control to relieve the congestion situation.

20. The information processing apparatus according to claim 19, wherein
the facility information includes information about a use record of the reward, and
the processor is further programmed to:
when the use record in the facility does not satisfy a predetermined condition, change the details of issuance of the reward for the facility.

21. The information processing apparatus according to claim 19, wherein
the facility information includes information about a congestion situation of the facility, and
the processor is further programmed to:
change the details of issuance of the reward for the facility, according to the congestion situation of the facility.

22. The information processing apparatus according to claim 20, wherein
the issuance information includes information about at least one of a content of the reward, a maximum number of the rewards issued, a range of issuing the rewards, and an available time period, and
the processor is further programmed to:
change at least one of the content of the reward, the maximum number of the rewards issued, the range of issuing the rewards, and the available time period.

23. The information processing apparatus according to claim 19, wherein
the processor is further programmed to:
determine whether the user intends to use the issued reward, based on the user's behavior, and issue the reward issued to the user to other users, when the user does not intend to use the reward.

24. An information processing system comprising:
the information processing apparatus according to claim 19; and
a terminal device that receives the reward issued by the information processing apparatus.

25. An information processing method comprising:
in accordance with a type of a store on a movement route from an event facility to a predetermined point or a use method of the store, selecting a target user from a plurality of the users, based on congestion information including a congestion situation on the movement route and user position information indicating a position of each user, and providing the selected target user with a reward that is according to the type or the use method of the store, in accordance with the user position information of the target user.
